(19) United States
(12) Patent Application Publication
(10) Pub. No.: US 2024/0051604 A1
(43) Pub. Date: Feb. 15, 2024

(54) Method for Assisting a Driver of a Motor Vehicle During a Parking Manoeuvre, and Motor Vehicle

(71) Applicant: Volkswagen Aktiengesellschaft, Wolfsburg (DE)

(72) Inventors: Philipp Hüger, Rühen (DE); Bastian Göricke, Wolfsburg (DE)

(73) Assignee: Volkswagen Aktiengesellschaft, Wolfsburg (DE)

(21) Appl. No.: 18/260,890

(22) PCT Filed: Dec. 10, 2021
(86) PCT No.: PCT/EP2021/085297

§ 371 Date: Sep. 12, 2023

(30) Foreign Application Priority Data
Jan. 11, 2021 (DE) 10 2021 200 188.2

(51) Int. Cl. B62D 15/02; G08G 1/16; G08G 1/14

(52) U.S. Cl. CPC B62D 15/028; G08G 1/168; G08G 1/143

(57) ABSTRACT

The disclosure relates to a method for operating a motor vehicle in which a driver of the motor vehicle is assisted during a parking operation by at least one indication being output. Here, at least one trajectory along which the motor vehicle can be moved into a target position in one move is communicated to the driver. When a multiple-move parking operation has to be performed in order to reach the target position from an actual position of the motor vehicle, a start position which is different from the actual position and from which the motor vehicle can be moved into the target position in one move is communicated to the driver by means of an assistance apparatus of the motor vehicle.

### CROSS-REFERENCE TO RELATED APPLICATIONS

This application claims priority to German Patent Application No. DE 10 2021 200 188.2, filed on Jan. 11, 2021 with the German Patent and Trademark Office. The contents of the aforesaid Patent Application are incorporated herein for all purposes.

### TECHNICAL FIELD

The invention relates to a method for operating a motor vehicle in which a driver of the motor vehicle is assisted during a parking operation by at least one indication being output. Here, at least one trajectory along which the motor vehicle can be moved into a target position in one move is communicated to the driver. The invention further relates to a motor vehicle for assisting a driver during a parking operation.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

Motor vehicles that are currently available may have parking assistance systems in which the driver themselves drives past a parking space, stops, and then engages the reverse gear. If the driver in the motor vehicle has activated a parking assistance function of the system, the indication that no parking space has yet been found or that a parking space has been found but the motor vehicle cannot move into the parking space from the actual position of the motor vehicle can appear on a display of the motor vehicle. Furthermore, it can be displayed to the driver on the display that they have now reached a position at which they should engage the reverse gear in order to maneuver the motor vehicle into the parking space.

However, in the case of a parking assistance system of this kind, it is possible that the driver stops at a location from which a parking operation is only possible in multiple moves. This is not only laborious but also more time-consuming than single-move parking, i.e., parking in just one move.

Furthermore, it is possible that the driver stops at a location from which it is not at all possible to park, for example because there is not sufficient space to perform a corresponding steering deflection of steerable wheels of the motor vehicle due to other parked motor vehicles or the like. In such a case, no assistance function of the motor vehicle in which the motor vehicle automatically performs steering deflections of the steerable wheels of the motor vehicle can be activated. This is also disadvantageous with respect to parking that is as quick as possible.

### SUMMARY

A need exists to provide a method which allows for a particularly simple and quick parking and to provide a motor vehicle configured for carrying out the method.

The need is addressed by the subject matter of the independent claims. Embodiments of the invention are described in the dependent claims, the following description, and the drawings.

### BRIEF DESCRIPTION OF THE DRAWINGS

FIG. 1 shows an example situation in which a motor vehicle drives past parking lots, most of which are already occupied by other motor vehicles, wherein potentially available parking spaces are measured by means of suitable sensors of the motor vehicle;

FIG. 2 shows the example situation according to FIG. 1, wherein a suitable parking space has been found by the motor vehicle and areas around the motor vehicle from which a single-move parking maneuver is possible are determined by an evaluation apparatus of the motor vehicle;

FIG. 3 schematically shows the parking space according to FIG. 2 as well as differently marked subareas of a region within which there are start positions of the motor vehicle from which parking is possible in one move, wherein the subareas are assigned to different classes that correspond to a simplicity of the single-move parking operation;

FIG. 4 shows an example assistance of the driver during the parking operation in one move proceeding from the situation shown in FIG. 2;

FIG. 5 shows a possible example variant of assisting the driver during the single-move parking operation, in that the motor vehicle is superimposed on an image or camera image taken by means of a camera system of the motor vehicle and displayed on a display of the motor vehicle;

FIG. 6 shows the example situation according to FIG. 5, wherein the motor vehicle superimposed on the camera image is located outside the region within which a single-move parking operation is possible, wherein a start position is marked within the region in order to display to the driver from where they can move the motor vehicle into the parking space in one move;

FIG. 7 shows an example display of the motor vehicle on which the camera image and the motor vehicle are displayed, wherein the motor vehicle is now located at the start position marked in FIG. 6;

FIG. 8 shows an example display of a region on the display according to FIG. 5 during the search for a parking lot or rather the search for a parking space, wherein parking in the parking space is possible in one move from a start position within this region;

FIG. 9 shows example situations in which, on account of a travel lane occupied by other parked vehicles, single-move parking is not possible at one time and parking in one move is possible at one time; and

FIG. 10 schematically shows an example motor vehicle that is designed to assist the driver during the single-move parking operation.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In the method according to some embodiments for operating a motor vehicle, a driver of the motor vehicle is assisted during a parking operation by at least one indication being output. At least one trajectory along which the motor vehicle can be moved into a target position in one move is communicated to the driver. In the method, when a multiple-move parking operation has to be performed in order to reach the target position from an actual position of the motor vehicle, a start position which is different from the actual position is communicated to the driver by means of an assistance apparatus of the motor vehicle. The motor vehicle can move from the start position into the target position in one move.

The assistance apparatus therefore ensures that the driver of the motor vehicle can reliably reach the start position from which single-move and thus time-efficient parking is possible. Consequently, by means of the method, particularly simple and quick parking can be achieved.

Furthermore, the method makes it possible to perform a trained or learned parking operation from the start position, in which parking operation the motor vehicle automatically or autonomously travels along a trajectory of which the parameters were previously stored in a corresponding apparatus of the motor vehicle. This also results in improved assistance of the driver during the parking operation.

In some embodiments, the method makes it possible, for example in a narrow alley and/or in the case of an oncoming lane blocked by other motor vehicles, for the driver to be guided in a targeted manner to the start position from which the single-move parking operation can be performed even in such difficult conditions. As a result, the method can beneficially be used in particularly diverse situations.

For example, when the target position is reached by the motor vehicle, the parking operation is completed. In this case, guidance of the motor vehicle from the start position in the one move to the target position, which corresponds, for example, to a parking position of the motor vehicle in a parking space, involves particularly little effort.

For example, the assistance apparatus assists the driver with reaching the start position with the motor vehicle by outputting the at least one indication. In this way, it can be ensured that the driver reaches the start position that is favorable for the single-move parking operation in a particularly reliable and quick manner.

For example, at least one dimension of the motor vehicle is taken into account by an evaluation apparatus of the motor vehicle in order to determine the start position. For example, such a dimension may include a length, a width, a wheel base of the motor vehicle, or the like. Such geometric data of the motor vehicle are helpful when determining the start position.

Additionally or alternatively, a maximum possible steering deflection of at least one steerable wheel of the motor vehicle can be taken into account by the evaluation apparatus of the motor vehicle. This is also beneficial with regard to the reliable determination of a promising start position for the single-move parking operation.

Furthermore, parameters such as a distance between the motor vehicle and at least one obstacle arranged in the surroundings of the motor vehicle during travel along the trajectory and/or at least one dimension of a parking space in which the motor vehicle is located when it reaches the target position can be taken into account by the evaluation apparatus of the motor vehicle in order to determine the start position. Parameters of this kind are also helpful for the determination of the start position.

For example, a plurality of trajectories along each of which the motor vehicle can be moved into the target position in one move is communicated to the driver by the assistance apparatus. Here, the respective trajectory is assigned to a class and the class to which the respective trajectory belongs is communicated to the driver. In this way, the driver obtains the information that, in principle, different trajectories can be used to reach the target position. This produces a particularly high degree of flexibility with regard to the single-move parking. And by means of the assignment of the trajectory to a respective class, the driver for example receives information as to how the respective trajectory is to be assessed, for example, with respect to a simplicity of the parking operation. This is beneficial for the driver, because the driver can therefore establish the extent to which a trajectory that is possible in principle appeals to them.

For example, a magnitude of at least one steering deflection of at least one steerable wheel of the motor vehicle to be performed when traveling along the trajectory is taken into account by an evaluation apparatus of the motor vehicle when assigning the respective trajectory to the class.

Additionally or alternatively, a number of steering deflections of at least one steerable wheel of the motor vehicle to be performed when traveling along the trajectory can be taken into account by the evaluation apparatus of the motor vehicle. Parameters of this kind thus correspond to how easy or convenient or efficient the respective trajectory is with regard to reaching the target position.

Additionally or alternatively, parameters such as a distance between the motor vehicle and at least one obstacle arranged in the surroundings of the motor vehicle during travel along the trajectory and/or a use of a travel lane provided for at least one road user other than the motor vehicle during travel along the trajectory and/or a length of the trajectory can be taken into account by the evaluation apparatus of the motor vehicle when assigning the respective trajectory to the class.

Parameters of this kind are also well suited for the assignment of the respective trajectory to one of the classes. This is because such parameters also correlate with how easy travel along the trajectory can be made or how quickly the trajectory can be covered. This is also beneficial with regard to a quick and simple parking operation to be performed.

In particular, based on the class to which the respective trajectory is assigned, the driver can make a good estimate of how easily the parking operation can be performed from the start position. As a result, the driver can use a trajectory that fits particularly well with their individual preferences or, alternatively, move to another start position if the trajectory beginning at said start position seems more favorable or easier to them with regard to the parking operation.

For example, as the at least one indication, the assistance apparatus displays at least one direction arrow to the driver on a display of the motor vehicle and/or gives the driver at least one recommendation for actuating a steering handle of the motor vehicle. Additionally or alternatively, an acoustic indication can also be output to the driver by the assistance apparatus. Indications of this kind are helpful both when traveling along the trajectory and for reaching the target position.

Additionally or alternatively, as the at least one indication, the assistance apparatus displays the start position to the driver on a display of the motor vehicle. For example, the start position may be marked on the display by means of a symbol, for example a finish flag or the like. In this way, the driver is given an easily understandable indication as to the location of the start position from which the parking operation can be performed in one move and thus particularly quickly and easily.

It has proven particularly beneficial if, as the at least one indication, the assistance apparatus displays to the driver on a display of the motor vehicle at least one region in the surroundings of the motor vehicle within which the at least one trajectory is located. In this way, the driver can be instructed in a very comprehensible manner as to from where in the surroundings of the motor vehicle single-move parking operations are possible at all in relation to the actual position of the motor vehicle. This is beneficial for the subsequent performance of the single-move parking maneuver or parking operation.

In particular, the at least one trajectory and an assignment of the at least one trajectory to one of the classes can be marked in the at least one region. In this regard, it can be provided, for example, that the region is divided into subareas that correspond to a respective class. In particular, it can be provided that the respective trajectory can be marked as belonging to the class which corresponds to the subarea within which the respective trajectory begins. In this way, the assignment of the trajectories beginning within the region to the respective classes is particularly easy for the driver to comprehend.

For example, the assistance apparatus assists the driver during travel along the trajectory by outputting the at least one indication. This makes the parking operation very easy for the driver if the driver performs at least part of the parking operation themselves, i.e., if the driver themselves performs driving maneuvers such as acceleration and/or braking, maintenance of a (for example low) travel speed and/or actuation of a steering handle of the motor vehicle or the like.

For example, the at least one indication is superimposed on an image taken by means of at least one camera of the motor vehicle and displayed to the driver. By using augmented reality (AR) in this way, the at least one indication can be output to the driver in a particularly intuitive manner. This is particularly helpful, both for assisting the driver for the purpose of reaching the start position and during travel along the trajectory.

Additionally or alternatively, the at least one indication can be displayed on a display of a navigation system of the motor vehicle. For example, the indication can be communicated in a very comprehensible manner to the driver on a screen of the navigation system.

Additionally or alternatively, it is possible to communicate the at least one indication to the driver by means of a head-up display of the motor vehicle. A display or display apparatus of this kind, in which the indication is superimposed on the field of view of the driver while said driver is looking through a windscreen of the motor vehicle, can also beneficially be used for outputting the indication to the driver.

For example, the motor vehicle is moved by means of a control apparatus of the motor vehicle that is designed for autonomous guidance of the motor vehicle from the start position into the target position in one move. In this case, the driver does not need to perform actions themselves in order to move the motor vehicle along the trajectory and into the target position in one move. Rather, the control apparatus designed for autonomous guidance of the motor vehicle provides corresponding steering deflections of at least one steerable wheel of the motor vehicle as well as onward movement and braking of the motor vehicle during travel along the trajectory and when the target position has been reached. This makes the method particularly low-effort and convenient for the driver.

For example, the start position and/or the at least one trajectory is communicated to the driver by the assistance apparatus if the driver informs the assistance apparatus that a parking operation is to be performed. For example, the driver can inform the assistance apparatus that they intend to park the motor vehicle in a parking space by actuating a corresponding control element. Subsequently, the driver is assisted by the assistance apparatus as early as during the search for the parking space. For example, it can in particular be provided that the driver can already identify and drive to a suitable stopping position as the start position when driving past a parking space. Subsequently, the parking operation can be performed particularly well and easily.

This is beneficial, if for example further motor vehicles on an oncoming lane restrict the space available for parking and thus a suitable start position for the single-move parking by the driver alone cannot be easily found. Consequently, assistance of this kind for the driver is particularly beneficial.

The motor vehicle according to some embodiments is designed to assist a driver of the motor vehicle during a parking operation by at least one indication being output. The motor vehicle is further designed to communicate to the driver at least one trajectory along which the motor vehicle can be moved into a target position in one move. The motor vehicle comprises an assistance apparatus which is designed to communicate to the driver a start position that is different from the actual position if a multiple-move parking operation has to be performed from an actual position of the motor vehicle in order to reach the target position. The motor vehicle can move from the start position into the target position in one move. Consequently, the motor vehicle is designed to carry out the method according to some embodiments such that a particularly simple and quick parking operation can be performed by means of the motor vehicle.

The benefits described for the method and the various embodiments also apply to the motor vehicle and vice versa.

Also belonging to the disclosure are thus, in particular, embodiments of the motor vehicle that have features which have already been described in conjunction with the embodiments of the method. For this reason, the corresponding embodiments are not described again here for the motor vehicle.

The invention also includes combinations of the features of the described embodiments.

In the following, further exemplary embodiments of the invention are described. Reference will be made to the drawings in which the various elements of embodiments will be given numerical designations and in which further embodiments will be discussed.

Specific references to components, process steps, and other elements are not intended to be limiting.

In the embodiments described herein, the described components of the embodiments each represent individual features that are to be considered independent of one another, in the combination as shown or described, and in combinations other than shown or described. In addition, the described embodiments can also be supplemented by features other than those described.

Elements having the same functions are, in each case, provided with the same reference numerals in the FIGS.

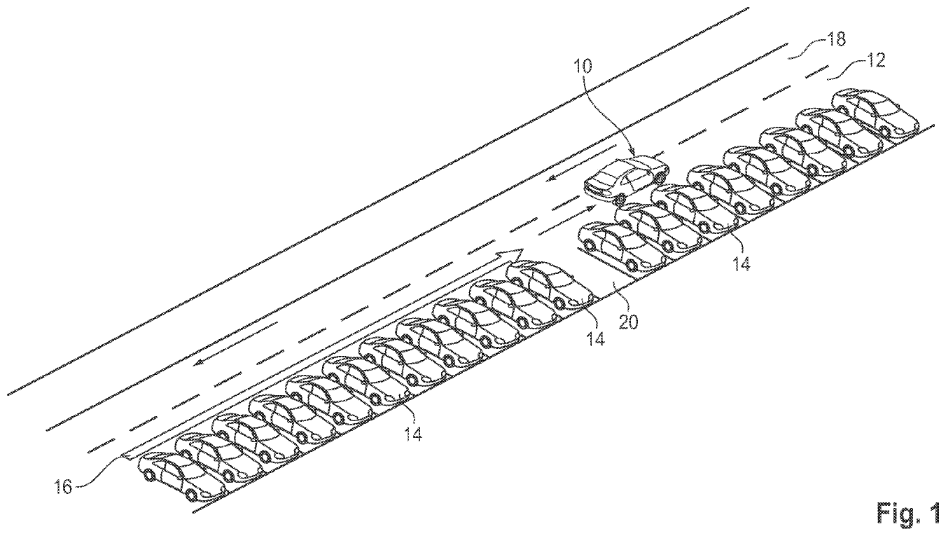

FIG. 1 shows a motor vehicle 10 that is driving on a travel lane 12 past parked vehicles 14, of which only some are provided with a reference sign for reasons of clarity. A travel direction of the motor vehicle 10, which is also shown schematically in FIG. 10, when driving past the parked vehicles 14 is illustrated in FIG. 1 by an arrow 16. Furthermore, an oncoming lane 18 is shown, which can be traveled on by other vehicles (not shown). A parking space 20 is located between two of the parked vehicles 14. Parking spaces 20 of this kind are measured by means of suitable sensors of the motor vehicle 10 when driving past the parking lots.

FIG. 1 shows a situation in which a suitable parking space 20, i.e. a parking space 20 of which the dimensions make it possible for the motor vehicle 10 to park there, has been found by the motor vehicle 10. For this purpose, measured values provided by the sensors are evaluated by a corresponding apparatus of the motor vehicle 10.

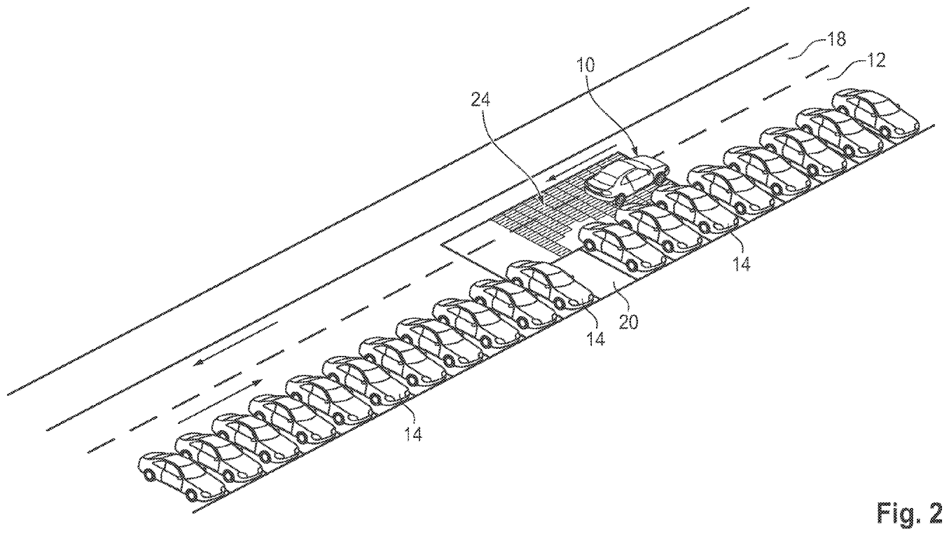

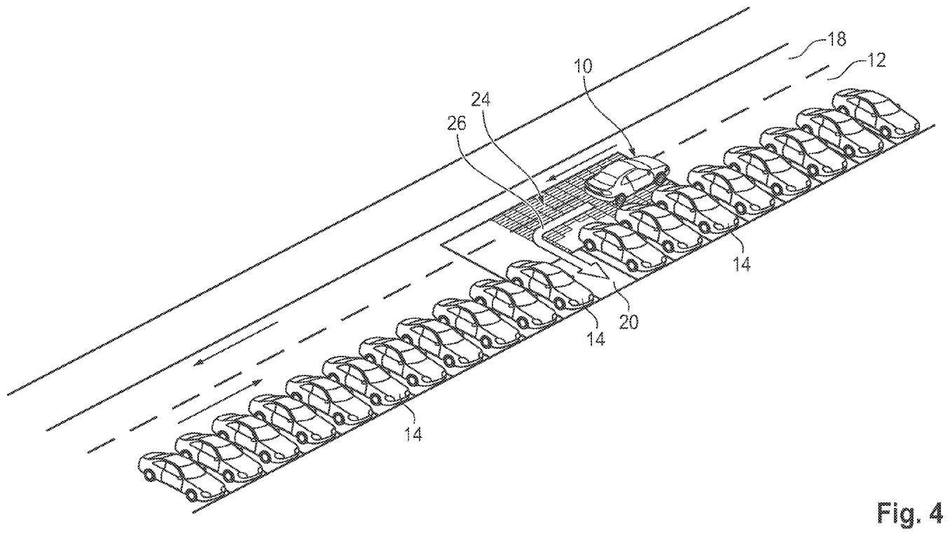

An evaluation apparatus 22 of the motor vehicle 10 (cf. FIG. 10) then determines a region 24 (cf. FIG. 2) around the motor vehicle 10 within which there are possible start positions of the motor vehicle 10 from which a single-move parking maneuver is possible. In other words, within the region 24 shown schematically in FIG. 2, which was determined by means of the evaluation apparatus 22 of the motor vehicle 10, there is a plurality of trajectories along which the motor vehicle 10 can be moved into a target position in one move. An exemplary trajectory 26 of this kind that is located within the region 24 is shown schematically in FIG. 4. However, there is a large number of such trajectories 26 within the region 24 that allow for a single-move parking operation. If the motor vehicle 10 is thus located within the region 24, no tiresome back-and-forth maneuvering of the motor vehicle 10 is required in order to park the motor vehicle 10 in the parking space 20 at a target position. Rather, the target position can be reached in one move from every start position within the region 24. During parking in one move, a gear engaged at one time at the start position, i.e., for example, a reverse gear of the motor vehicle 10 in the presently shown example, can be maintained unchanged until the target position in the parking space 20 has been reached. In contrast, during parking in multiple moves, at least one change of, for example, a reverse gear into a forward gear or vice versa is required.

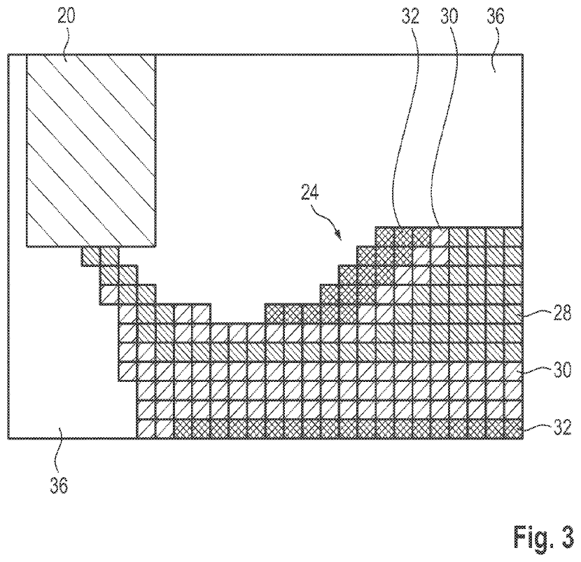

The possibility of single-move parking will now be explained based on FIG. 3. Specifically, FIG. 3 schematically shows the region 24 within which the start positions from which a single-move parking operation or single-move parking maneuver is possible are located. In other words, the motor vehicle 10 can then be moved into the parking space 20 in one move if the motor vehicle is located at any location of said region 24.

The area or rather region 24 can also be referred to as a heat map (thermal image). According to FIG. 3, as in the case of a thermal image taken by means of a thermal imaging camera, different subareas 28, 30, 32 in the region 24 are for example marked so as to be distinguishable from one another. For example, the subareas 28, 30, 32 may have different colors in order for them to be distinguishable from one another. However, other forms of representation of the subareas 28, 30, 32 are possible in order to make said subareas 28, 30, 32 distinguishable from one another, for example the use of different cross-hatching and/or showing differently designed respective trajectories 26 that start within one of the subareas 28, 30, 32.

For example, trajectories along which the motor vehicle 10 can be maneuvered in a particularly simple manner into the parking space 20 can be marked within the first subarea 28 by means of first, relatively thick arrows. Arrows present in the second subareas 30 can be designed so as to be thinner in comparison or can differ in another way from the first arrows shown within the first subarea 28. And in the third subareas 32, further, again thinner arrows or the like can in turn denote trajectories along which the motor vehicle 10 can be moved in order to arrive at the parking space 20. The different design of the respective arrow thus signifies that a respective trajectory 26 belongs to a particular class.

In the present case, however, it should be assumed for illustrative reasons that the subareas 28, 30, 32 of the region 24 are in different colors. The color of the respective subarea 28, 30, 32 corresponds to the assignment of the subarea 28, 30, 32 to a particular class.

For example, the first subarea 28 shown in FIG. 3 can be displayed in green. Trajectories for parking the motor vehicle 10 in a single move and which allow for particularly convenient, simple, and efficient movement of the motor vehicle 10 into the parking space 20 are for example located within the green subarea 28.

In contrast, laterally adjoining the first subarea 28 are the second subareas 30, which may for example be colored yellow or have a yellow color. The yellow color of the second subareas 30 indicates that, although a single-move parking operation is still possible in the case of a start position of the motor vehicle 10 within the second subareas 30, this is less convenient or simple than if the start position were located within the first subarea 28.

Further, third subareas 32 adjoin the second subareas 30 at the edges. If the motor vehicle 10 is located on one of said third subareas 32 shown by way of example in FIG. 3, a single-move parking operation is also still possible from a corresponding start position of the motor vehicle 10. However, this is significantly less convenient or simple than in the case where the motor vehicle 10 is located on the first subarea 28.

A trajectory for parking the motor vehicle 10 in a single move may begin, for example, on one of the third subareas 32, then may traverse one of the second subareas 30, and may finally lead to the target position in the parking space 20 within the first subarea 28. In such a case, said trajectory is for example assigned to the class in which the third subarea 32 is found. Analogously, a trajectory which begins on one of the second subareas 30 and then leads to the target position in the parking space 20 within the first subarea 28 is for example assigned to the class in which the second subarea 30 is found.

A series of criteria can be used by the evaluation apparatus 22 which are taken into account during assignment to a respective class of a respective trajectory 26 that allows for the single-move parking operation, i.e. the movement of the motor vehicle 10 into the parking space 20 in one move.

For example, said criteria may include the smallest possible steering angles or, in other words, a magnitude of at least one steering deflection of steerable wheels 34 (cf. FIG. 10) of the motor vehicle 10 to be performed during travel along the trajectory 26. Furthermore, the fact that there should be the greatest possible distances from obstacles located in the surroundings of the motor vehicle 10 can be taken into account by the evaluation apparatus 22 (cf. FIG. 10) of the motor vehicle 10 as a criterion for assigning the respective trajectory 26 to one of the classes. The fact that the oncoming lane 18 is not traveled on or is traveled on as little as possible when the motor vehicle 10 is being maneuvered into the parking space 20 can also be taken into account by the evaluation apparatus 22 as a further criterion. A number of steering deflections to be performed when traveling along the trajectory 26 can also be taken into account when the respective trajectory 26 (cf. FIG. 4) is assigned to one of the respective classes by the evaluation apparatus 22.

In the example illustrated using FIG. 3, for all trajectories 26 (not shown specifically in FIG. 3) that are located within the first subarea 28, said trajectories are particularly favorable or rather optimal with regard to the convenience and simplicity of the parking operation. Said trajectories 26 are thus assigned to the first or best class. If the motor vehicle is located on one of the second subareas 30 shown in yellow in FIG. 3, the trajectory 26 is not ideal, but is assigned to the middle range or rather to a middle or second class in consideration of the criteria mentioned by way of example above.

However, if the motor vehicle 10 is located on one of the third subareas 32 shown in red in FIG. 3, a single-move parking operation is still possible, but the assessment of the criteria is borderline. The corresponding trajectories are thus assigned to a third class. For example, relatively large steering angles may be required here, and many steering movements must be performed or there are obstacles at relatively short distances in the surroundings of the motor vehicle, or travel over the oncoming lane 18 may occur to a significant extent and for a long period of time during the single-move parking operation.

Further areas 36 shown in FIG. 3 without a color, for example in white, are located outside the region 24. If the motor vehicle 10 is located on one of these areas 36, no single-move parking operation is possible any more.

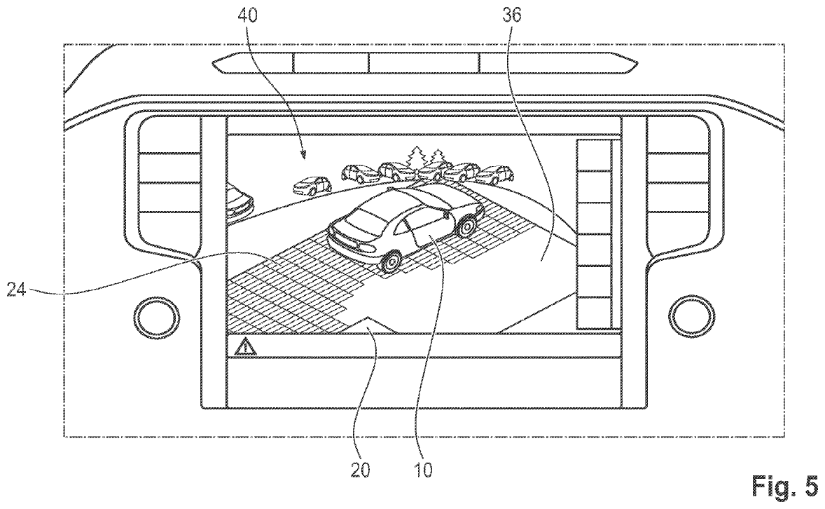

An assistance apparatus 38 of the motor vehicle 10 represented in a highly schematic manner in FIG. 10 assists the driver of the motor vehicle 10 during the parking operation. The assistance can take place by outputting indications via a user interface of the motor vehicle 10, for example by displaying indications on a screen 40, shown in FIG. 5, of the motor vehicle 10 or on a display of this kind.

In this way, direction arrows, for example, can be displayed on the screen 40, or steering recommendations can be output on the screen 40 or on a display of this kind. Additionally or alternatively, it is possible to display on the screen 40 suitable areas or regions over which the motor vehicle 10 travels during the single-move parking. As shown by way of example in FIG. 5, the heat map or rather the region 24 within which the start positions from which the single-move parking is possible are located can be displayed on the screen 40, in particular directly. In the region 24 displayed on the screen 40, for example the subareas 28, 30, 32 shown schematically in FIG. 3 can accordingly be marked.

Furthermore, it is possible to use a form of representation in which augmented reality (AR) is used. For example, an image or rather camera image or video image that can be taken by means of at least one camera 42 (cf. FIG. 10) of the motor vehicle 10 can be displayed on the screen 40. The motor vehicle 10 can be superimposed on this video image, as illustrated in FIG. 5. Therefore, the driver looking at the screen 40 not only sees an image or video image of the actual surroundings, but also the representation of their own vehicle 10 in the actual surroundings as well as the surroundings of the motor vehicle 10 and the region 24 superimposed on said surroundings.

FIG. 5 accordingly shows a 360-degree view of the motor vehicle 10, i.e. the surroundings of the motor vehicle 10 in all directions around the motor vehicle 10, wherein a representation of the motor vehicle 10 is superimposed on this view. This augmented view of the 360-degree camera system, on which the motor vehicle 10 is superimposed, is particularly helpful for assisting the driver during the parking operation.

However, it is also possible for the motor vehicle 10 to comprise a rear view camera (cf. FIG. 10) as one of the cameras 42 and for the region 24 or corresponding indications to be superimposed on an image taken by said rear view camera. In particular, in such a case, it is not necessary to additionally superimpose the motor vehicle 10 itself on the camera image or video image.

Furthermore, it is possible to use a head-up display 44 of the motor vehicle 10 (cf. FIG. 10) in order to output assisting indications to the driver during the parking operation. At least one indication that visually assists the driver during the parking operation can be superimposed on a field of view of the driver looking through a windscreen of the motor vehicle 10 by means of the head-up display 44.

It is also possible to display the motor vehicle 10 and, additionally, the surroundings around the motor vehicle 10 in a bird's eye view on the screen 40 or a display of this kind of the motor vehicle 10. The area or rather the region 24 with the subareas 28, 30, 32 can also be superimposed very well and clearly on a representation of this kind. In addition or as an alternative to visual aids of this kind, the driver can also be assisted by the assistance apparatus 38 of the motor vehicle 10 by means of acoustic instructions during the single-move parking operation.

By means of the output of the at least one indication, the driver is informed, for example, of the trajectory 26 on which or, alternatively, of the subareas 28, 30, 32 within which they have to move the motor vehicle 10 in order to park the motor vehicle 10 in one move.

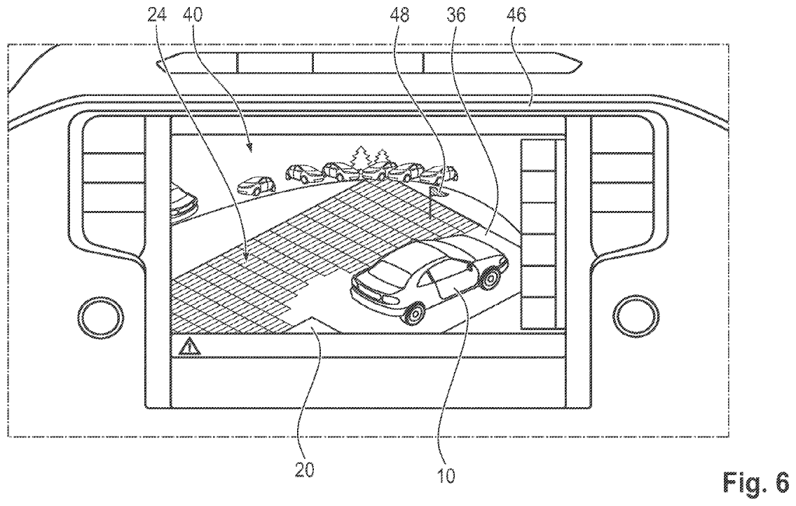

FIG. 6 shows a situation in which the motor vehicle 10 is located outside the region 24, i.e., on one of the areas 36 according to FIG. 3. In the present case, this is also visualized on the screen 40 of the motor vehicle 10, which may be arranged, for example, in a dashboard 46 of the motor vehicle 10. In this case, the assistance apparatus 38 can communicate to the driver indications or rather a driving instruction as to how they can easily arrive back as quickly as possible at a suitable area within the region 24, i.e. one of the subareas 28, 30, 32. This is because the single-move parking is possible from these subareas 28, 30, 32.

For example, a flag 48 or a symbol of this kind, which depicts a start position suitable for the single-move parking for the driver, can be displayed within the region 24. The flag 48, which marks the start position in the case of the variant of the assistance apparatus 38 illustrated by way of example based on FIG. 6, is also displayed in the situation shown in FIG. 6 in the video image that can be seen on the screen 40. At least one section of the surroundings of the motor vehicle 10 and, additionally, the motor vehicle 10 are also displayed in this video image.

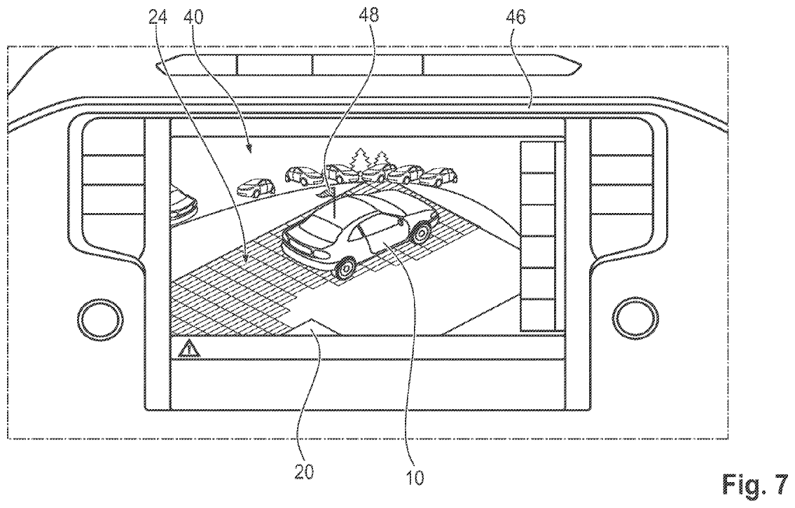

FIG. 7 shows the situation in which the driver has moved the motor vehicle 10 into the start position, i.e., to the location within the region 24 at which the flag 48 or a symbol of this kind is located. Accordingly, the motor vehicle 10 is then located at the position of the flag 48. This situation is also displayed to the driver of the motor vehicle 10, for example on the screen 40, in that both the motor vehicle 10 and the flag 48, which may overlap with the motor vehicle 10 or may be located on a roof of the motor vehicle 10 in the representation, are superimposed on the surroundings of the motor vehicle 10 visible on the screen 40.

The flag 48 may, in particular, be displayed in a different color if the motor vehicle 10 has reached said start position according to FIG. 7, i.e., is located within the region 24 from which the single-move parking is possible. In this way, it can be illustrated to the driver particularly well that the motor vehicle 10 is now located at the suitable start position from which the motor vehicle 10 can be moved into the parking space 20 in one move.

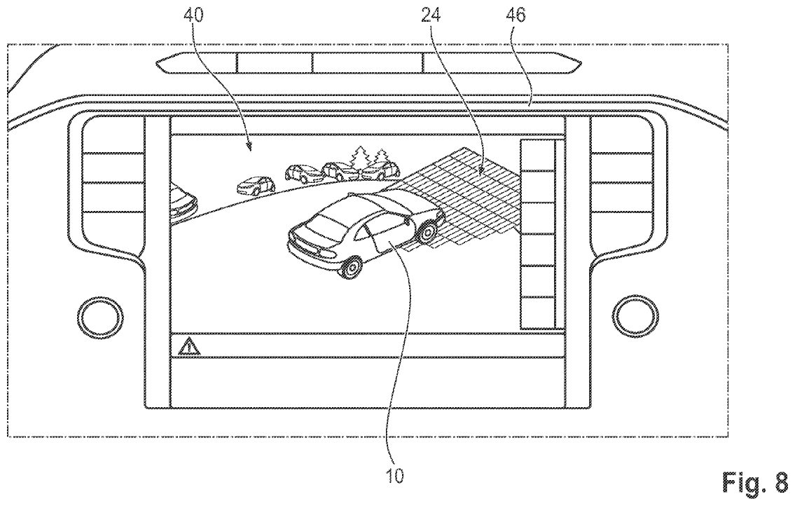

A further beneficial application scenario will be illustrated with reference to FIG. 8. For example, the assistance apparatus 38 can already assist the driver when they are on the search for a parking space 20 during forward travel, i.e. during the movement along the arrow 16 shown in FIG. 1. For example, a suitable heat map or rather the suitable region 24 from which a single-move parking operation into the parking space 20 is possible can already be displayed, in particular on the screen 40, during said forward travel. In this way, the driver can already identify an optimal stopping position when first stopping after driving past the parking space 20 and then drive to said stopping position as the start position. This is because, whenever the motor vehicle 10 is located within the region 24, the motor vehicle 10 is simultaneously located at a suitable start position from which the motor vehicle 10 can be moved into the target position, i.e. into the parking space 20, in one move. Therefore, the subsequent parking operation can be performed in an optimal manner.

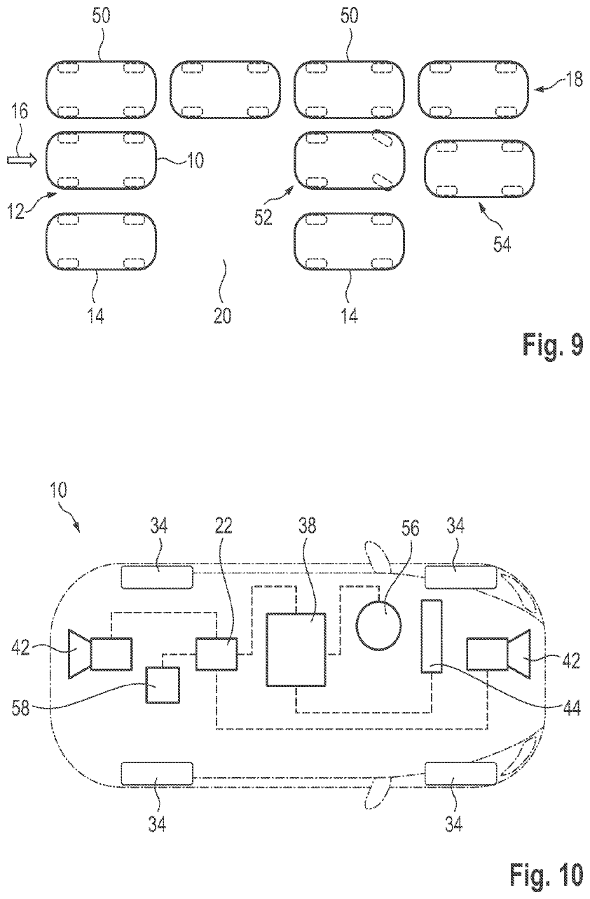

Another application scenario that will be explained with reference to FIG. 9 is given, for example, when further vehicles 50 are located on the oncoming lane 18 (cf. FIG. 1). Vehicles 50 of this kind can namely make maneuvering with the motor vehicle 10 more difficult. For example, FIG. 9 shows the motor vehicle 10 in a first position 52 from which no single-move parking operation is possible. This is because, on account of the deflection of the steerable wheels 34 of the motor vehicle 10, a collision with at least one of the vehicles 50 located on the oncoming lane 18 would occur during the subsequent reverse travel of the motor vehicle 10.

Furthermore, FIG. 9 shows another position 54 of the motor vehicle 10 from which single-move parking into the parking space 20 is possible without any problems. If the motor vehicle 10 is therefore located at the position 54, said position 54 is a good start position, in particular an optimal start position, which is for example located within the first subarea 28 in the region 24 shown in FIG. 3.

It can be provided that, during parking, the driver of the motor vehicle 10 actuates a steering handle such as a steering wheel 56 (cf. FIG. 10) of the motor vehicle 10 themselves and/or starts up, accelerates, and brakes the motor vehicle 10 themselves, while being assisted by indications that are output by the assistance apparatus 38.

However, it is also possible for the motor vehicle 10 to comprise a control apparatus 58 (cf. FIG. 10) that is designed to autonomously guide the motor vehicle 10. For example, the control apparatus 58 can provide for moving the motor vehicle 10 autonomously from the start position located within the region 24 into the target position and thus into the parking space 20 after the driver of the motor vehicle 10 has brought or rather driven the motor vehicle 10 to the start position marked, for example, by means of the flag 48.

Therefore, by means of indications or rather instructions that are output by the assistance apparatus 38, the driver of the motor vehicle 10 can be assisted with arriving at the start position from which the motor vehicle 10 can autonomously perform the single-move parking operation. In the case of a trained parking operation of this kind, the surroundings of the motor vehicle 10 can be recorded, in particular, by means of the at least one camera 42 of the motor vehicle 10 in order to maneuver the motor vehicle 10 into the parking position on a learned trajectory. The driver of the motor vehicle 10 can therefore also be merely assisted with reaching the start position from which the control apparatus 58 then maneuvers the motor vehicle 10 into the parking space without the driver of the motor vehicle 10 having to be active in this.

The vehicles 50 on the oncoming lane 18 shown schematically in FIG. 9 as well as the vehicles 14 adjoining the parking space 20 are shown as examples of obstacles that may be located in the surroundings of the motor vehicle 10.

Furthermore, it can be seen from FIG. 1 and FIG. 9 that the method can be used for assisting the driver with parking of the motor vehicle 10 into a parking space 20 oriented transversely to the travel direction as well as into a parking space 20 oriented in parallel with the travel direction of the motor vehicle 10. In FIG. 1, the parking space 20 is shown as a perpendicular parking space by way of example and, in FIG. 9, the parking space 20 is shown as a parallel parking space by way of example.

In summary, the examples show how the motor vehicle 10 can implement a system for single-move parking with AR assistance for an optimal start position and a trajectory 26 for single-move parking.

### LIST OF REFERENCE NUMERALS

10 Motor vehicle
12 Travel lane
14 Vehicle
16 Arrow
18 Oncoming lane
20 Parking space
22 Evaluation apparatus
24 Region
26 Trajectory
28 Subarea
30 Subarea
32 Subarea
34 Wheel
36 Area
38 Assistance apparatus
40 Screen
42 Camera
44 Head-up display
46 Dashboard
48 Flag
50 Vehicle
52 Position
54 Position
56 Steering wheel
58 Control apparatus

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit or device may fulfil the functions of several items recited in the claims.

The term “exemplary” used throughout the specification means “serving as an example, instance, or exemplification” and does not mean “preferred” or “having advantages” over other embodiments. The term “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1-10. (canceled)

11. A method for operating a motor vehicle, wherein
a driver of the motor vehicle is assisted during a parking operation, comprising:
outputting at least one indication and communicating to the driver at least one trajectory along which the motor vehicle can be moved into a target position in one move;
when a multiple-move parking operation has to be performed in order to reach the target position from an actual position of the motor vehicle, determining a start position which is different from the actual position and from which the motor vehicle can be moved into the target position in one move; and
outputting the start position to the driver.

12. The method of claim 11, further comprising assisting the driver with reaching the start position with the motor vehicle by outputting the at least one indication.

13. The method of claim 11, wherein, in order to determine the start position, one or more of the following is taken into account by an evaluation apparatus of the motor vehicle:
at least one dimension of the motor vehicle,
a maximum possible steering deflection of at least one steerable wheel of the motor vehicle,
a distance between the motor vehicle and at least one obstacle arranged in the surroundings of the motor vehicle during travel along the trajectory, and
at least one dimension of a parking space in which the motor vehicle is located when it reaches the target position.

14. The method of claim 11, wherein a plurality of trajectories along each of which the motor vehicle can be moved into the target position in one move is communicated to the driver by the assistance apparatus, wherein the respective trajectory is assigned to a class and the class to which the respective trajectory belongs is communicated to the driver.

15. The method of claim 14, wherein, when assigning the respective trajectory to the class, one of more of the following is taken into account by an evaluation apparatus of the motor vehicle:
a magnitude of at least one steering deflection of at least one steerable wheel of the motor vehicle to be performed when traveling along the trajectory,
a number of steering deflections of at least one steerable wheel of the motor vehicle to be performed when traveling along the trajectory,
a distance between the motor vehicle and at least one obstacle arranged in the surroundings of the motor vehicle during travel along the trajectory,
a use of a travel lane provided for at least one road user other than the motor vehicle during travel along the trajectory, and
a length of the trajectory.

16. The method of claim 11, wherein, as the at least one indication, the assistance apparatus:
displays to the driver at least one direction arrow on a display of the motor vehicle, and/or
gives the driver at least one recommendation for actuating a steering handle of the motor vehicle, and/or
displays the start position to the driver on a display (40) of the motor vehicle, and/or
displays to the driver on a display of the motor vehicle at least one region in the surroundings of the motor vehicle within which the at least one trajectory is located.

17. The method of claim 11, wherein the at least one indication is superimposed on an image taken using at least one camera of the motor vehicle and displayed to the driver and/or
is displayed on a display of a navigation system of the motor vehicle and/or
is communicated to the driver by means of a head-up display of the motor vehicle.

18. The method of claim 11, wherein the start position and/or the at least one trajectory is communicated to the driver by the assistance apparatus if the driver informs the assistance apparatus that a parking operation is to be performed.

19. A motor vehicle which is designed to assist a driver of the motor vehicle during a parking operation by at least one indication being output, and which is designed to communicate to the driver at least one trajectory along which the motor vehicle can be moved into a target position in one move, wherein
the motor vehicle comprises an assistance system which is configured to communicate to the driver a start position which is different from the actual position and from which the motor vehicle can be moved into the target position in one move if a multiple-move parking operation has to be performed from an actual position of the motor vehicle in order to reach the target position.

20. The method of claim 12, wherein, in order to determine the start position, one or more of the following is taken into account by an evaluation apparatus of the motor vehicle:
at least one dimension of the motor vehicle,
a maximum possible steering deflection of at least one steerable wheel of the motor vehicle,
a distance between the motor vehicle and at least one obstacle arranged in the surroundings of the motor vehicle during travel along the trajectory, and
at least one dimension of a parking space in which the motor vehicle is located when it reaches the target position.

21. The method of claim 12, wherein a plurality of trajectories along each of which the motor vehicle can be moved into the target position in one move is communicated to the driver by the assistance apparatus, wherein the respective trajectory is assigned to a class and the class to which the respective trajectory belongs is communicated to the driver.

22. The method of claim 3, wherein a plurality of trajectories along each of which the motor vehicle can be moved into the target position in one move is communicated to the driver by the assistance apparatus, wherein the respective trajectory is assigned to a class and the class to which the respective trajectory belongs is communicated to the driver.

23. The method of claim 12, wherein, as the at least one indication, the assistance apparatus:
displays to the driver at least one direction arrow on a display of the motor vehicle, and/or
gives the driver at least one recommendation for actuating a steering handle of the motor vehicle, and/or
displays the start position to the driver on a display (40) of the motor vehicle, and/or
displays to the driver on a display of the motor vehicle at least one region in the surroundings of the motor vehicle within which the at least one trajectory is located.

24. The method of claim 13, wherein, as the at least one indication, the assistance apparatus:
displays to the driver at least one direction arrow on a display of the motor vehicle, and/or
gives the driver at least one recommendation for actuating a steering handle of the motor vehicle, and/or
displays the start position to the driver on a display (40) of the motor vehicle, and/or
displays to the driver on a display of the motor vehicle at least one region in the surroundings of the motor vehicle within which the at least one trajectory is located.

25. The method of claim 14, wherein, as the at least one indication, the assistance apparatus:
displays to the driver at least one direction arrow on a display of the motor vehicle, and/or
gives the driver at least one recommendation for actuating a steering handle of the motor vehicle, and/or
displays the start position to the driver on a display (40) of the motor vehicle, and/or
displays to the driver on a display of the motor vehicle at least one region in the surroundings of the motor vehicle within which the at least one trajectory is located.

26. The method of claim 15, wherein, as the at least one indication, the assistance apparatus:
displays to the driver at least one direction arrow on a display of the motor vehicle, and/or
gives the driver at least one recommendation for actuating a steering handle of the motor vehicle, and/or
displays the start position to the driver on a display (40) of the motor vehicle, and/or
displays to the driver on a display of the motor vehicle at least one region in the surroundings of the motor vehicle within which the at least one trajectory is located.

27. The method of claim 25, wherein the at least one trajectory and an assignment of the at least one trajectory to one of the classes can be marked in the at least one region.

28. The method of claim 26, wherein the at least one trajectory and an assignment of the at least one trajectory to one of the classes can be marked in the at least one region.

29. The method of claim 12, wherein the at least one indication is superimposed on an image taken using at least one camera of the motor vehicle and displayed to the driver and/or
is displayed on a display of a navigation system of the motor vehicle and/or
is communicated to the driver by means of a head-up display of the motor vehicle.

30. The method of claim 13, wherein the at least one indication is superimposed on an image taken using at least one camera of the motor vehicle and displayed to the driver and/or
is displayed on a display of a navigation system of the motor vehicle and/or
is communicated to the driver by means of a head-up display of the motor vehicle.
